(19) United States
(12) Patent Application Publication
(10) Pub. No.: US 2026/0078810 A1
(43) Pub. Date: Mar. 19, 2026

(54) WHEEL HUB BRAKE ROTOR

(71) Applicant: Consolidated Metco, Inc., Vancouver, WA (US)

(72) Inventors: Tianjiao Yu, Vancouver, WA (US); Nicolas Trent Meacham, Vancouver, WA (US); Conor Liam Crowley, Spokane, WA (US); Lawrence Michael Joseph Pileri, Tigard, OR (US)

(21) Appl. No.: 19/333,910

(22) Filed: Sep. 19, 2025

Related U.S. Application Data
(60) Provisional application No. 63/696,476, filed on Sep. 19, 2024.

(51) Int. Cl. F16D 65/12; B60B 27/00; F16D 65/02

(52) U.S. Cl. CPC F16D 65/123; B60B 27/0052; B60B 2320/10; B60B 2360/104; B60B 2900/131; B60B 2900/212; B60B 2900/531; F16D 2065/1308; F16D 2200/0008

(57) ABSTRACT

A U-shaped brake rotor including a body that is rotatable around a central axis. The body has an interior to receive a wheel hub, an inboard brake disc, an outboard mounting flange, and an annular wall portion. The outboard mounting flange includes a lug having a through opening to receive a fastener to secure the lug to a wheel mounting flange of the wheel hub. The lug further includes an inboard inclined surface extending radially outward as the inboard inclined surface extends away from the annular wall portion of the body. The inboard inclined surface of the lug extends around the through opening and includes a radially outer portion radially outward of the through opening, a radially inner portion radially inward of the through opening, and an intermediate portion on either side of the through opening and connecting the radially outer and inner portions of the inboard inclined surface.

### CROSS-REFERENCE TO RELATED APPLICATION

This application claims benefit of U.S. Provisional Application No. 63/696,476, filed Sep. 19, 2024, which is hereby incorporated herein by reference in its entirety.

### TECHNICAL FIELD

This disclosure relates generally to brake rotors for vehicles and, more specifically, relates to brake rotors that are connected to wheel hubs of vehicles.

### BACKGROUND

One type of wheel hub assembly includes a wheel hub, a U-shaped brake rotor, and bolts securing the rotor to the wheel hub. If the rotor is not concentrically aligned with the wheel hub, radial run out and associated vibration of the wheel hub assembly may occur during operation of the vehicle.

To concentrically align the rotor on the wheel hub during assembly, the wheel hub and rotor may have cooperating pilots that concentrically align the rotor and wheel hub as the rotor is positioned on the wheel hub. Once the rotor has been positioned on the wheel hub, the installer advances threaded shanks of the bolts through openings in a flange of the wheel hub and into threaded openings of a flange of the rotor. The bolts are tightened down to secure the rotor to the wheel hub.

Wheel hubs may be made of different materials including iron and aluminum. Aluminum wheel hubs may be lighter than iron wheel hubs but may be less rigid than a similar wheel hub made of iron. Accordingly, rotor flange and pilot configurations that are suitable for iron hubs may not be suitable for aluminum wheel hubs since the rotor flange and pilot configurations may include stress risers that cause excess stress in the aluminum material during operation of the vehicle. The excess stress in the rotor and/or wheel hub can cause premature failure of the wheel hub assembly. Further, the rotor flange may need to fit within a narrow area of the vehicle wheel end to avoid interference with a brake caliper of the vehicle.

Another issue with aluminum wheel hubs is that the material of an aluminum wheel hub may have a higher coefficient of thermal expansion than the material of a similar iron wheel hub. Due to the higher coefficient of thermal expansion, the aluminum wheel hub may expand radially outward against a pilot of the associated U-shaped brake rotor and cause increased stress in the barrel of the rotor during operation of the vehicle. These issues, among others, complicate the use of a U-shaped brake rotor with an aluminum wheel hub.

### SUMMARY

In one aspect of the present disclosure, a U-shaped brake rotor for a wheel hub assembly is provided. The brake rotor includes a body that is rotatable around a central axis and has a unitary, one-piece construction. The body of the brake rotor includes an interior to receive a wheel hub, an inboard brake disc, an outboard mounting flange, and an annular wall portion connecting the inboard brake disc and the outboard mounting flange. The outboard mounting flange includes a lug having a through opening to receive a fastener to secure the lug to a wheel mounting flange of the wheel hub. The lug further includes an inboard inclined surface extending radially outward as the inboard inclined surface extends away from the annular wall portion of the body. The inboard inclined surface of the lug extends around the through opening and includes a radially outer portion radially outward of the through opening, a radially inner portion radially inward of the through opening, and an intermediate portion on either side of the through opening and connecting the radially outer and inner portions of the inboard inclined surface. The inboard inclined surface provides clearance for a brake caliper, or other brake system component of the vehicle, and reduces the weight of the brake rotor. Further, the lug having the inboard inclined surface enables the lug to be thick and angled proximate the wheel mounting flange of the wheel hub to resist bending forces from the wheel mounting flange. Still further, the inclined configuration of the radially outer, intermediate, and radially inner portions of the inboard inclined surface around the through opening of the lug minimizes stress risers about the through opening and improves the durability of the brake rotor.

The present disclosure also provides a U-shaped brake rotor for a wheel hub assembly. The U-shaped brake rotor includes a body that is rotatable around a central axis and has a unitary, one-piece construction. The body includes an interior to receive a wheel hub, a brake disc, and a mounting flange. The brake rotor includes a sacrificial pilot in the interior of the body to contact the wheel hub and center the body on the wheel hub. The sacrificial pilot is configured to wear out of contact with the wheel hub during operation of the wheel hub assembly. In this manner, the sacrificial pilot is present to contact the wheel hub and center the brake rotor on the wheel hub during assembly. The sacrificial pilot subsequently wears out and becomes spaced from the wheel hub. The spacing that develops between the worn-out sacrificial pilot and the wheel hub improves the durability of the rotor hub because the spacing inhibits contact between the pilot and the wheel hub that could introduce additional stress into the rotor and cause premature failure.

### BRIEF DESCRIPTION OF DRAWINGS

FIG. 1 is a perspective view of a wheel hub assembly including a U-shaped brake rotor connected to a wheel hub;

FIG. 2 is a cross-sectional view taken along line 2-2 in FIG. 1 showing a flange portion of the rotor connected to a flange of a wheel hub;

FIG. 3 is an enlarged view of the area indicated by the dashed circle and reference numeral 3 in FIG. 2, FIG. 3 showing a frustoconical shape of the flange portion as the flange extends radially outward along the wheel hub flange;

FIG. 4 is a perspective view of a portion of the rotor of FIG. 1 showing curved faces of lugs of the flange portion of the brake rotor that contribute to the frustoconical shape of the flange portion;

FIG. 5 is an enlarged view of the area indicated by the dashed circle and reference numeral 5 in FIG. 2, FIG. 5 showing a pilot of the rotor barrel engaging a pilot of the wheel hub;

FIG. 6 is a front elevational view of the rotor of FIG. 1 showing circumferential spacings between the lugs of the flange portion of the rotor;

FIG. 7 is a back elevational view of the rotor of FIG. 6 showing a central opening of the rotor;

FIG. 8 is a perspective view of a wheel hub body of FIG. 1 showing an outboard groove at a base of the flange;

FIG. 9 is a perspective view of the wheel hub body of FIG. 8 showing pilots of the wheel hub body circumferentially spaced around an inboard end portion of the wheel hub body;

FIG. 10 is an end elevational view of the wheel hub body of FIG. 9 showing the pitch diameter of stud holes of the flange being greater than a pitch diameter of bolt holes of the flange;

FIG. 11 is a cross-sectional view of another wheel hub assembly including a wheel hub and a brake rotor mounted thereto;

FIG. 12 is a perspective view of a wheel hub body of FIG. 11 showing an outboard end portion of the wheel hub including a flange;

FIG. 13 is a perspective view of the wheel hub body of FIG. 12 showing circumferentially spaced apart pilots of the wheel hub body inboard of the flange;

FIG. 14 is an end elevational view of the wheel hub body of FIG. 13 showing the pilots extending radially outward from a side wall of the wheel hub body;

FIG. 15 is a perspective view of another rotor having an interior with axially extending sacrificial pilots for contacting pilots of a wheel hub and concentrically aligning the rotor on a wheel hub during assembly;

FIG. 16 is an end elevational view of a portion of the rotor of FIG. 15 showing the sacrificial pilots extending radially inward for contacting the pilots of the wheel hub;

FIG. 17 is a perspective view of another rotor having an interior with an inboard circumferential sacrificial pilot and an outboard circumferential sacrificial pilot;

FIG. 18 is a cross-sectional view taken across line 18-18 in FIG. 17 showing the inboard and outboard sacrificial pilots each having tapered surfaces and an axially extending annular surface for contacting an associated pilot of a wheel hub;

FIG. 19 is a cross-sectional view of a portion of another rotor having a single circumferential sacrificial pilot; and

FIG. 20 is a cross-sectional view of a portion of another rotor having a circumferential sacrificial pilot with a profile configured to form a line contact with a pilot of a wheel hub.

### DETAILED DESCRIPTION

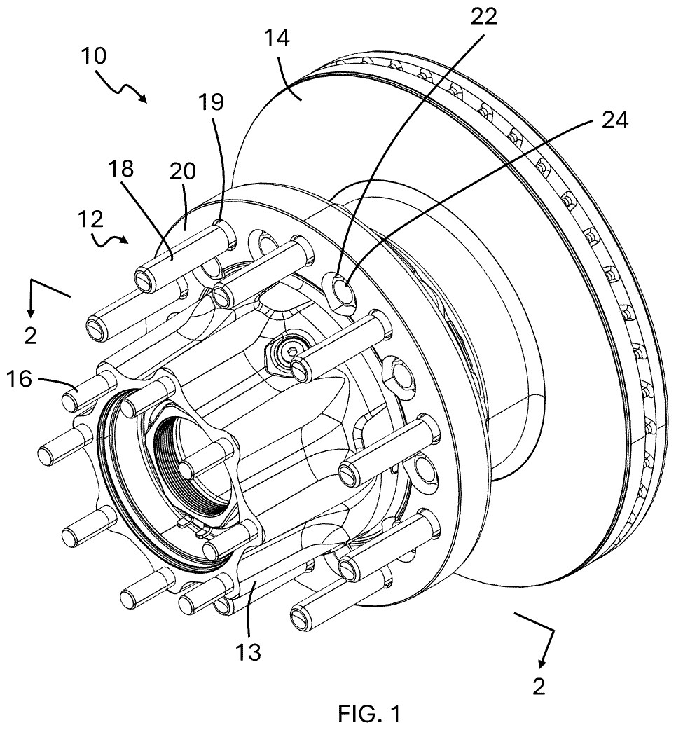

With reference to FIG. 1, a wheel hub assembly 10 is provided that includes a wheel hub 12 having a wheel hub body 13 and a brake rotor 14 connected thereto. The wheel hub 12 is a drive hub and includes studs 16 to receive a drive flange of a drive shaft. The wheel hub body 13 includes a wheel mounting portion such as a flange 20 with studs 18 to extend through openings of a wheel. The flange 20 has openings 22 to receive fasteners, such as bolts 24, that secure the brake rotor to the wheel hub 12.

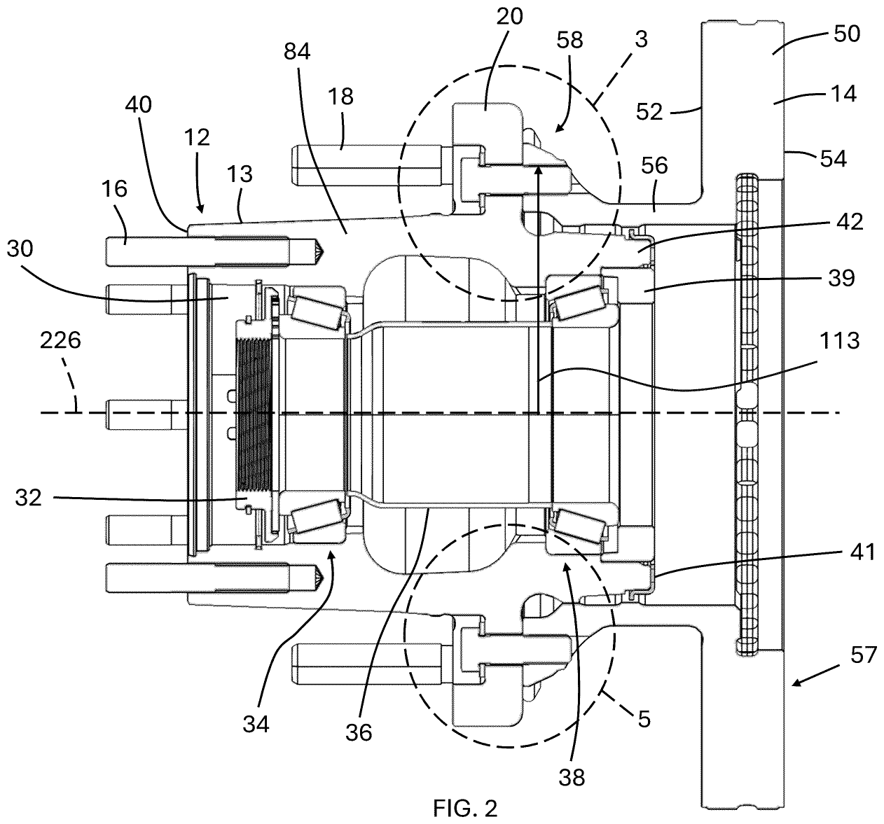

Referring to FIG. 2, the wheel hub 12 includes an interior 30 that receives a spindle lock nut assembly 32, an outboard bearing assembly 34, a spacer 36, an inboard bearing assembly 38, and a seal 39. The wheel hub body 13 has an outboard end portion 40 and an inboard end portion 42. The wheel hub 12 includes an ABS tone ring 41 mounted to the inboard end portion 42 of the wheel hub body 13.

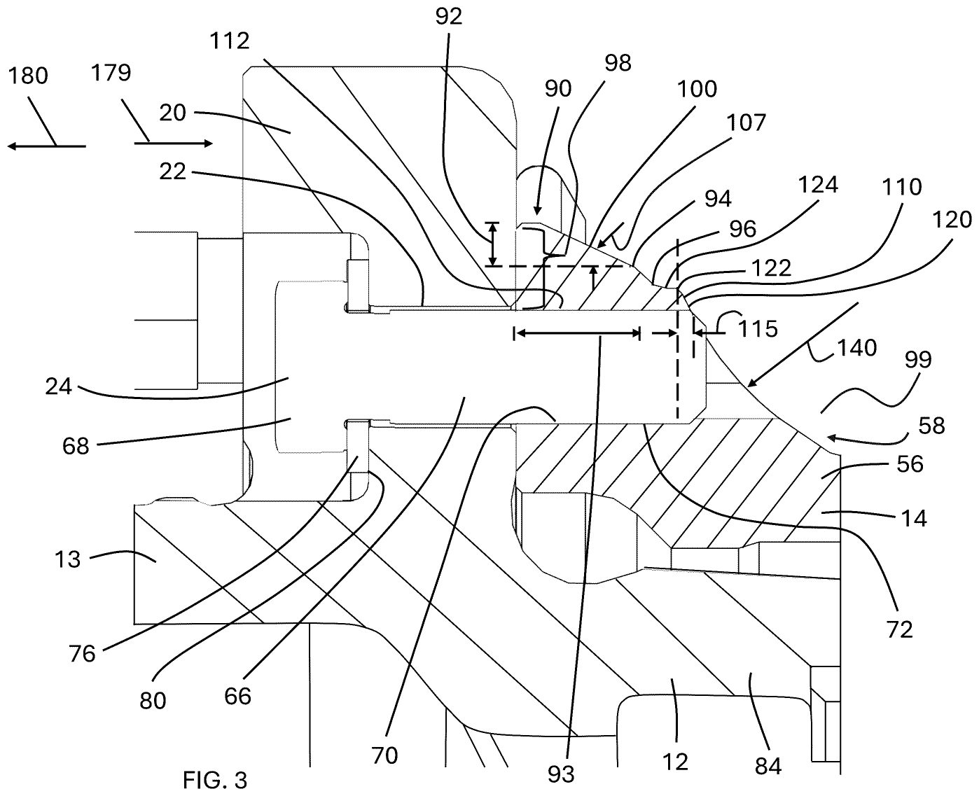

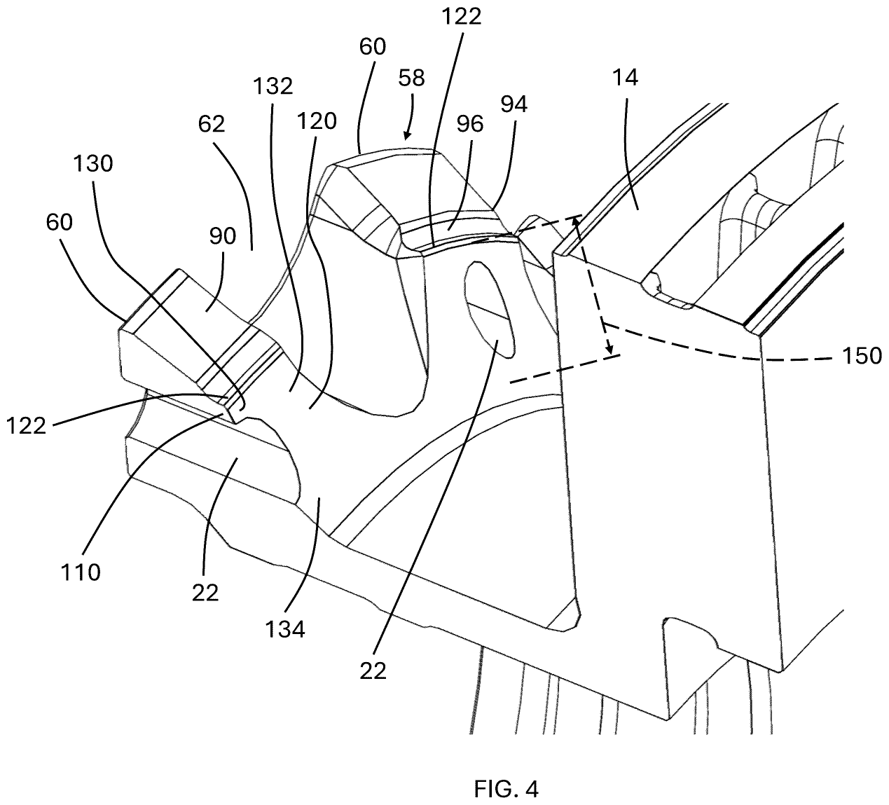

The rotor 14 has a U-shaped and includes a break disc, such as disc portion 50, with friction surfaces 52, 54 to be engaged by a brake caliper, an annular wall portion such as a barrel portion 56, and a mounting flange portion such as flange portion 58. With reference to FIG. 4, the flange portion 58 of the rotor 14 includes lugs 60 having circumferential spacings 62 therebetween and openings 22 of each lug 60 that receive a shank portion 66 (see FIG. 3) of one of the bolts 24. The shank portion 66 depends from a head portion 68 of the bolt 24 and has threads 70 that engage threads 72 of the opening 22 of the lug 60. In one embodiment, a washer 76 is provided between a seating surface 80 of the opening 22 and the head portion 68 of the bolt 24.

Referring to FIG. 3, the wheel hub body 13 has a unitary, one-piece construction including a side wall 84 from which the flange 20 extends radially outward therefrom. In one embodiment, the wheel hub body 13 is made of a non-ferrous material such as aluminum. In another embodiment, the wheel hub body 13 is made from a ferrous material but the geometry of the wheel hub body 13 is configured such that the wheel hub body 13 is capable of bending like an aluminum hub during vehicle operation. The rotor 14 has a body 57 that includes the disc portion 50, barrel portion 56, and flange portion 58. The body 57 has a unitary, one-piece construction that may be made of, for example, gray iron or other materials having a low relative ductility and, in some cases, low relative strength. In other embodiments, the rotor 14 may be made of compacted graphite iron, or nodular iron.

With reference to FIG. 3, the rotor flange portion 58 flares radially outward as the flange portion 58 extends toward the wheel hub flange 20. The additional material of the rotor flange portion 58 adjacent the wheel hub flange 20 supports the wheel hub body 13 during cornering or other events that impart bending forces in the wheel hub flange 20, which improves the durability of the wheel hub assembly 10. More specifically, the rotor flange portion 58 resists out-of-plane bending force imparted to the wheel hub flange 20 and reduces associated bending stress in the wheel hub flange 20 such as where the wheel hub flange 20 connects to the side wall portion 84 of the wheel hub body 13.

For example, as the vehicle travels around a corner, the wheel hub flange 20 may experience cornering forces that attempt to bend the wheel hub flange 20 relative to itself and relative to the side wall portion 84 of the wheel hub body 13. It has been discovered that bending forces acting on the wheel hub flange 20 in an inboard direction 179 may have a significant adverse effect on the lifespan of the wheel hub body 13. Thus, the flared flange portion 58 supports the wheel hub flange 20 against bending in inboard direction 179, which reduces stress in the wheel hub flange 20 and sidewall portion 84 and improves the durability of the wheel hub body 13.

The bolts 24 each behave individually during a cornering event and can be placed in either compression or tension depending upon the bending forces experienced by the portion of the wheel hub flange 20 near the bolt 24. The lugs 60 provide reinforcement to the portions of the wheel hub flange 20 near the bolts 24 and resist individual movement of the bolts 24.

Additionally, the flared flange portion 58 distributes compressive forces from the tightened-down bolts 24 over a larger surface area of the wheel hub flange 20 since the flared flange portion 58 extends radially outward along the wheel hub flange 20 farther than a conventional brake rotor. The flared flange portion 58 thereby strengthens the joint between the wheel hub flange 20 and the rotor flange portion 58.

With reference to FIG. 3, the flange portion 58 includes a flared portion 90 that extends radially outward a distance 92 from a groove 96 and extends an axial distance 93 outboard from the groove 96. The groove 96 may provide clearance for some brake calipers that may be used with the wheel hub assembly 10. The flared portion 90 includes a tapered radially outer surface 100 extending radially outward and outboard from an upper juncture 94 between the tapered surface 100 and a concave surface 101 of the groove 96. The tapered radially outer surface 100 extends at an angle 107 relative to an axial direction (see e.g., lower line of distance 92). The angle 107 is in the range of 15 degrees to approximately 35 degrees, such as 25 degrees. The flared portion 90 has a large contact area 98 above the bolt-receiving hole 22 provides increased surface area for the flange portion 58 of the rotor 14 to support the flange 20 of the wheel hub 12 and strengthens the joint between the rotor 14 and the wheel hub 12.

With continued reference to FIG. 3, the flange portion 58 includes a protruding portion 110 above (i.e., radially outward of) a radially outermost portion 112 of the opening 22. Regarding FIG. 2, the radially outermost portion 112 is at a radius 113 from a central axis 226 of the wheel hub assembly 10 and is at the top of the opening 22 as shown in FIG. 3. The protruding portion 110 protrudes inboard an axial distance 115 from a juncture 122 between the concave surface 124 of the groove 96.

Each lug 60 includes an inboard inclined surface such as a tapered surface 120. The tapered surface 120 extends radially inward and in an inboard direction from the juncture 122. The tapered surface 120 extends from the juncture 122, around the opening 22, and to the barrel portion 56 of the rotor 14. Stated differently, the tapered surface 120 flares radially outward as the tapered surface 120 extends in an outboard direction from the barrel portion 56 of the rotor 14 toward the juncture 122.

With reference to FIG. 4, the tapered surface 120 has a radially outer portion 130 above the opening 22, an intermediate portion 132 extending around the opening 22, and a radially inner portion 134 below the opening 22. The tapered surface 120 extends continuously around the opening 22 to limit stress risers in the lug 60 while providing clearance for a brake of a vehicle.

In one embodiment, the tapered surface 120 is concave and has a continuous radius 140 (see FIG. 3) throughout the radially outer portion 130, intermediate portion 132, and radially inner portion 134. The radius 140 is in the range of, for example, approximately 1.7 inches to approximately 2.2 inches, such as 1.95 inches. The tapered surface 120 cooperates with the flared portion 90 to provide a frustoconical shape to the flange portion 58 and lugs 60 thereof. The tapered surface 120 provides material of the lug 60 above, below, and to the sides of the opening 22 to increase the durability of the flange portion 58 of the rotor 14. Further, each lug 60 has an arcuate, continuous face 150 (see FIG. 4) around each opening 22 that avoids stress risers around the inboard side of the opening 22. Still further, the frustoconical shape of the flange portion defines an inboard recess 99 that provides clearance for a brake caliper of the vehicle and reduces the weight of the rotor 14. In another embodiment, the tapered surface 120 has a straight slope, e.g., a conical shape with an infinite radius.

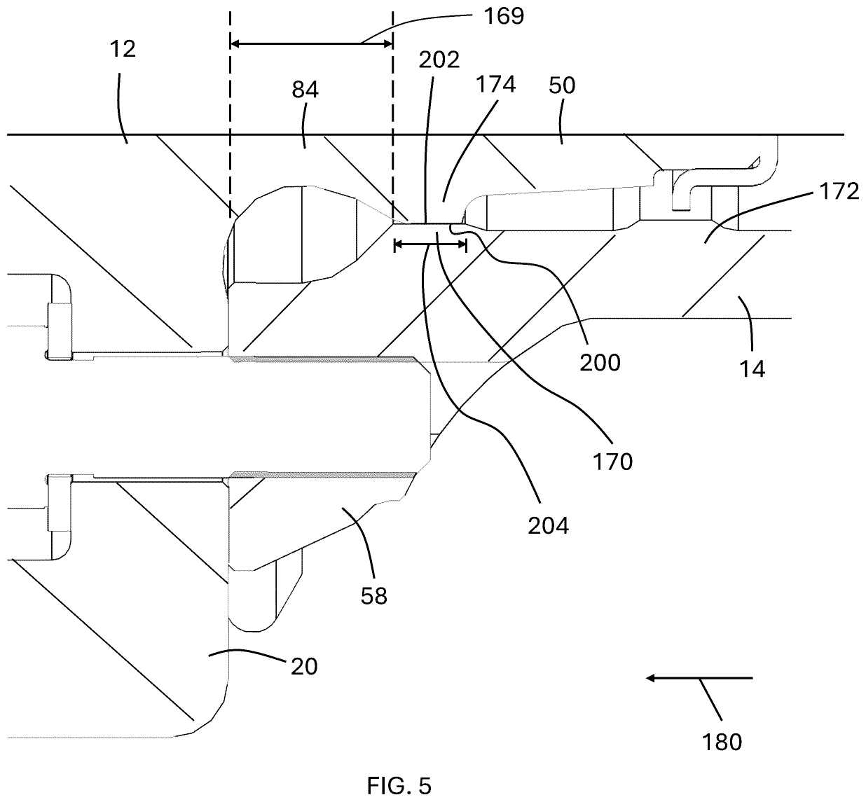

Referring to FIG. 5, the rotor 14 has one or more pilots 170 to contact one or more pilots 174 of the wheel hub 12 and concentrically align the rotor 14 on the wheel hub 12 as the rotor 14 is advanced in an outboard direction 180 toward the flange 20 during assembly of the rotor 14 and wheel hub 12. The pilots 174 are offset a distance 169 inboard from the flange 20 of the wheel hub 12 to position the interface between pilots 170, 174 away from the flange 20 and limit stress risers at the juncture between the flange 20 and the side wall 84 of the wheel hub body 13.

With reference to FIG. 5, the pilot 170 has an annular, axially extending surface 200 that engages an arcuate, axially extending surface 202 of the pilot 174. The engaged surfaces 200, 202 have a predetermined axial dimension 204 that may be sized to provide a desired amount of axial engagement to ensure concentric alignment of the rotor 14 on the wheel hub 12. Further, the pilot 170 remains engaged with the pilot 174 during operation of the vehicle and permits the rotor 14 to resist deflection of the flange 20 relative to itself and the side wall portion 84.

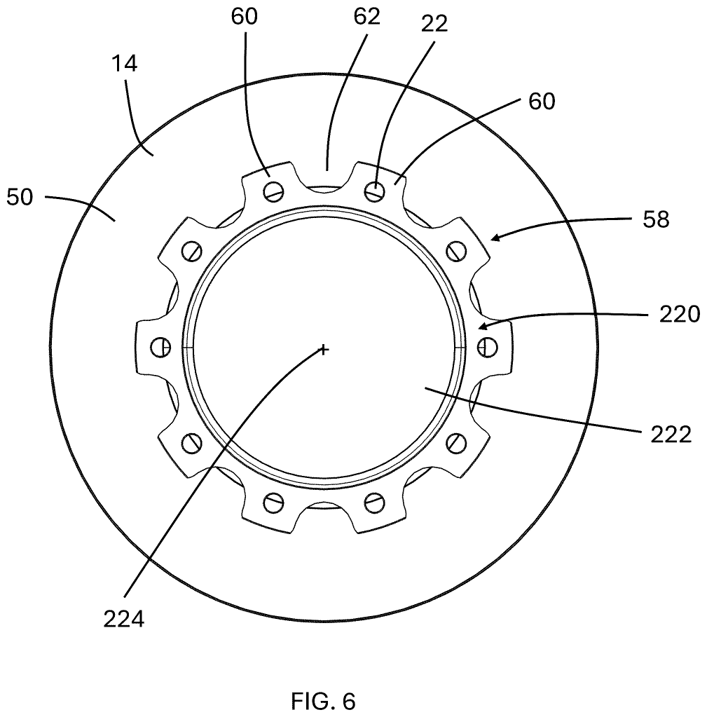

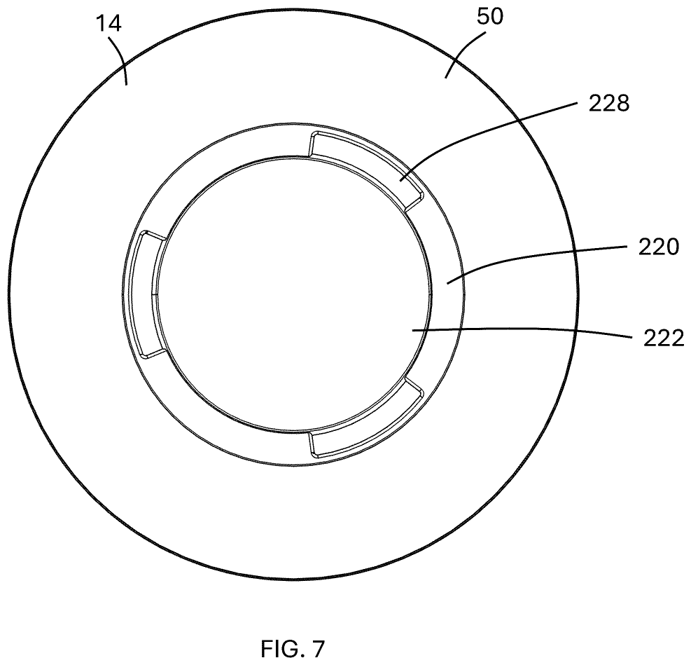

With reference to FIG. 6, the rotor 14 has a central portion 220 with a central opening 222 and extends around a central rotational axis 224 of the rotor 14. The lugs 60 extend radially outward like spokes from the central portion 220. Regarding FIG. 7, the inboard side of the central portion 220 of the rotor 14 has bosses 228 that may be used in manufacturing.

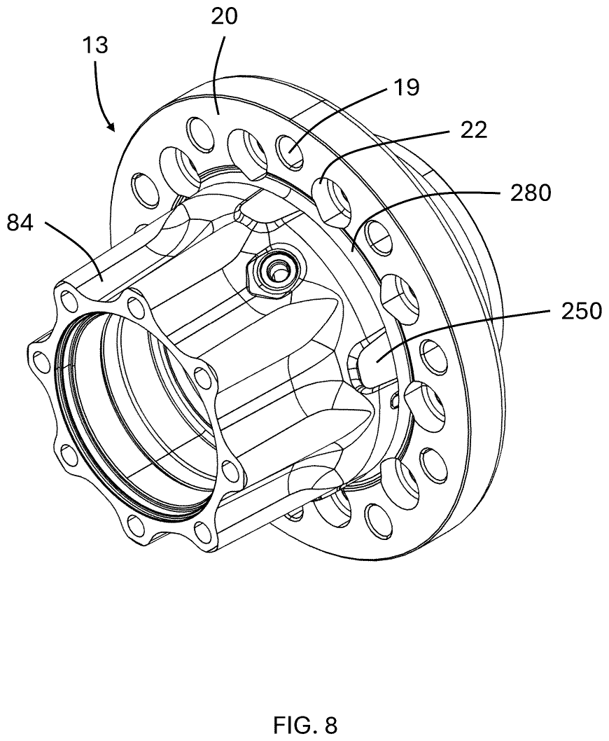

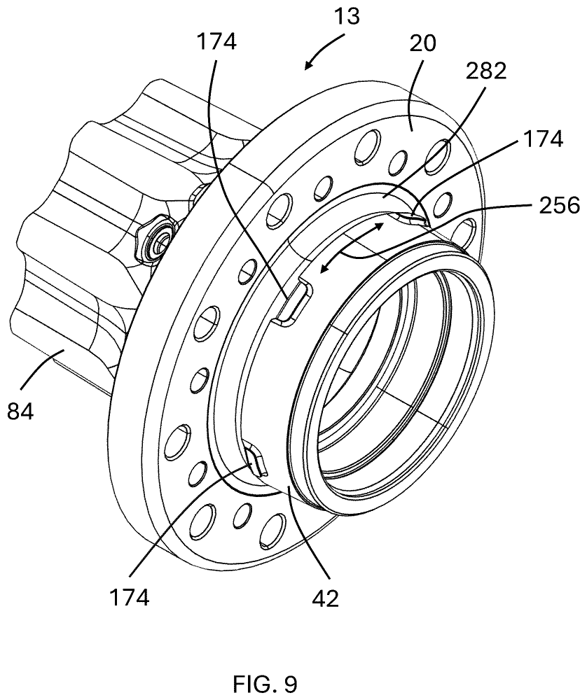

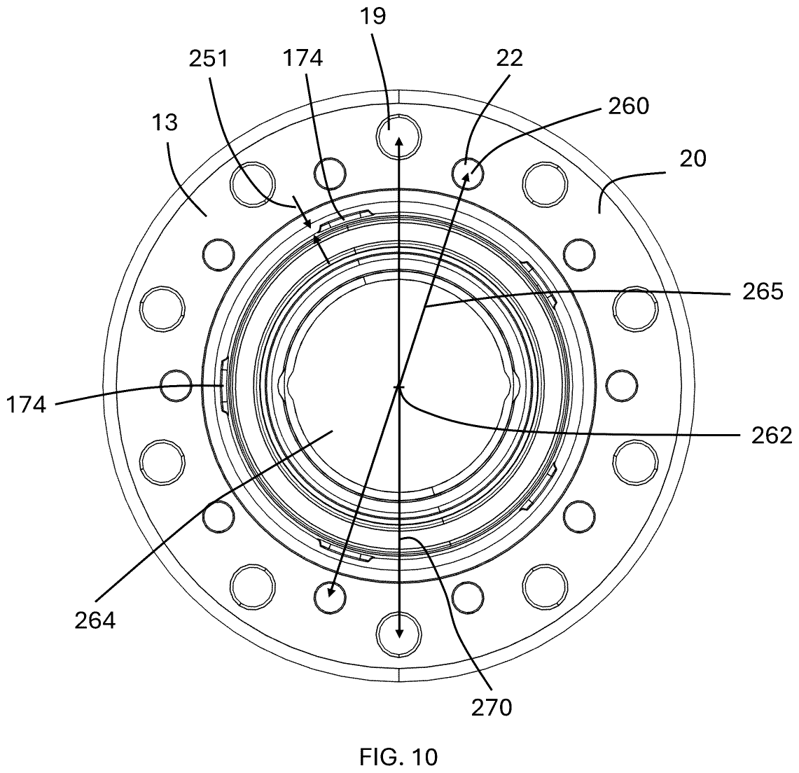

Referring to FIG. 8, the wheel hub 12 has wheel pilots 250 to center a wheel that is being connected to the wheel hub 12. Referring to FIGS. 9 and 10, the wheel hub 12 has rotor pilots 174 to center the rotor 14 as the rotor 14 is connected to the wheel hub 12. The pilots 174 extend radially outward from the inboard end portion 42 of the wheel hub body 13 such that the pilots 174 each have a height 251. The pilots 174 have a circumferential spacing 256 therebetween about the side wall 84. The number and size of the pilots 174 is selected with reference to the pilot 170 to provide a desired amount of contact to center the rotor 14 on the wheel hub body 13. For example, the pilots of the rotor 14 and wheel hub body 13 may be selected such that at least one pair of the pilots is engaged with the rotor 14 on the wheel hub body 13, regardless of the rotary orientation of the rotor 14.

Referring to FIG. 10, the openings 22 that receive the bolts 24 have a pitch diameter 265 extending between centers 260 of the openings 22 and across a center 262 of a central opening 264 of the wheel hub 12. The openings 19 that receive the studs 18 have a pitch diameter 270 that is greater than the pitch diameter 265. In this manner, the openings 22 are radially offset inward of the openings 19 and provides a compact packaging of the openings 22, 19 on the wheel hub flange 20.

Further, regarding FIGS. 8 and 9, the wheel hub 12 has an outboard groove 280 at the base of the flange 20 and an inboard groove 282 at an inboard base of the flange 20. The outboard groove 280 and inboard groove 282 each curve into the base of the flange 20 and provides a smooth transition between the side wall 84 and flange 20, which reduces stress concentrations between the flange 20 and the side wall 84.

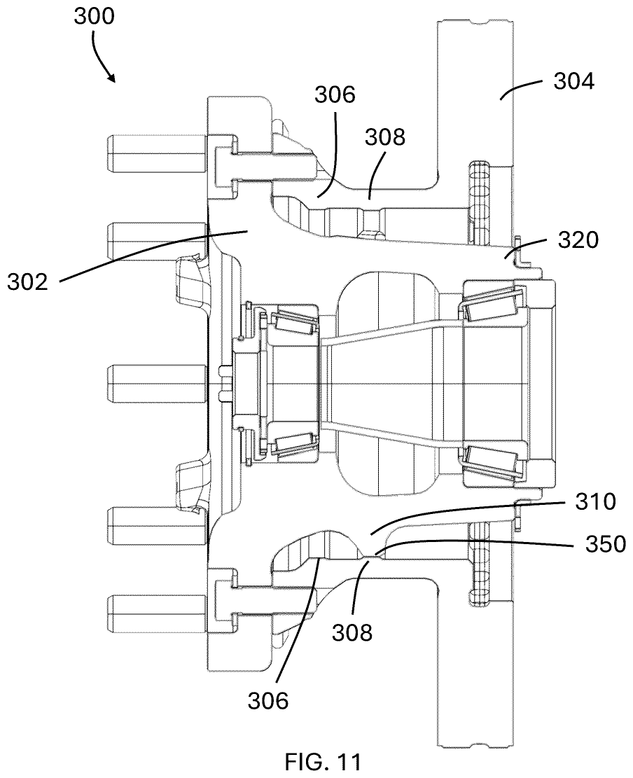

Regarding FIG. 11, a wheel hub assembly 300 is provided that includes a wheel hub 302 and a rotor 304 secured thereto. The rotor 304 is similar to the rotor 14 discussed above and includes outboard and inboard pilots 306, 308. The inboard pilot 308 engages a pilot 310 of the wheel hub 302 to center the rotor 304 on the wheel hub 302 whereas the outboard pilot 306 is in clearance with the wheel hub 302. The wheel hub 302 is a steer hub such that the inboard pilot 308 is used to concentrically align the rotor 304 and wheel hub 302. Alternatively, the rotor 304 may be used with a drive wheel hub, such as the wheel hub 12. If the rotor 304 is used with the wheel hub 12, the outboard pilot 306 will engage the pilots 174 of the wheel hub 12 while the inboard pilot 308 will be in clearance with the wheel hub 12. In this manner, the rotor 304 (like the rotor 14) can be used with either the steer wheel hub 302 or the drive wheel hub 12.

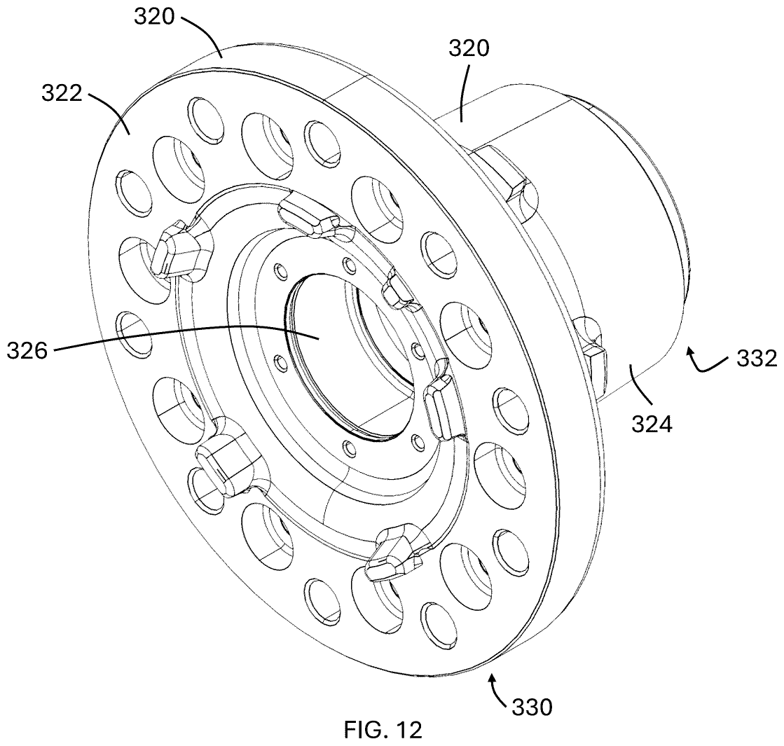

Regarding FIG. 12, the wheel hub 302 includes a body 320 having a flange 322 and a side wall 324 extending about a central bore or interior 326. The body 320 extends from an outboard end portion 330 to an inboard end portion 332.

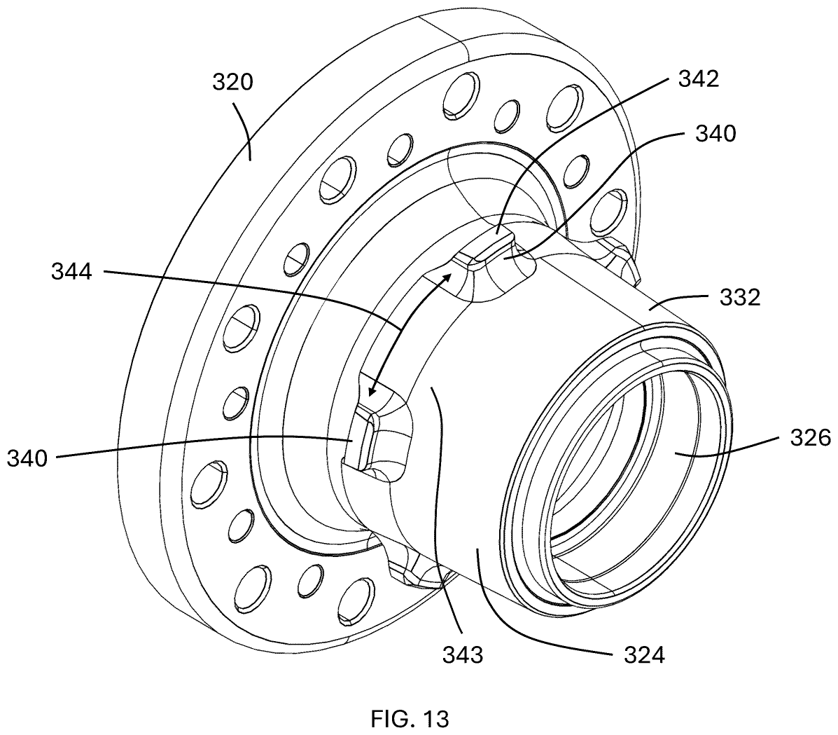

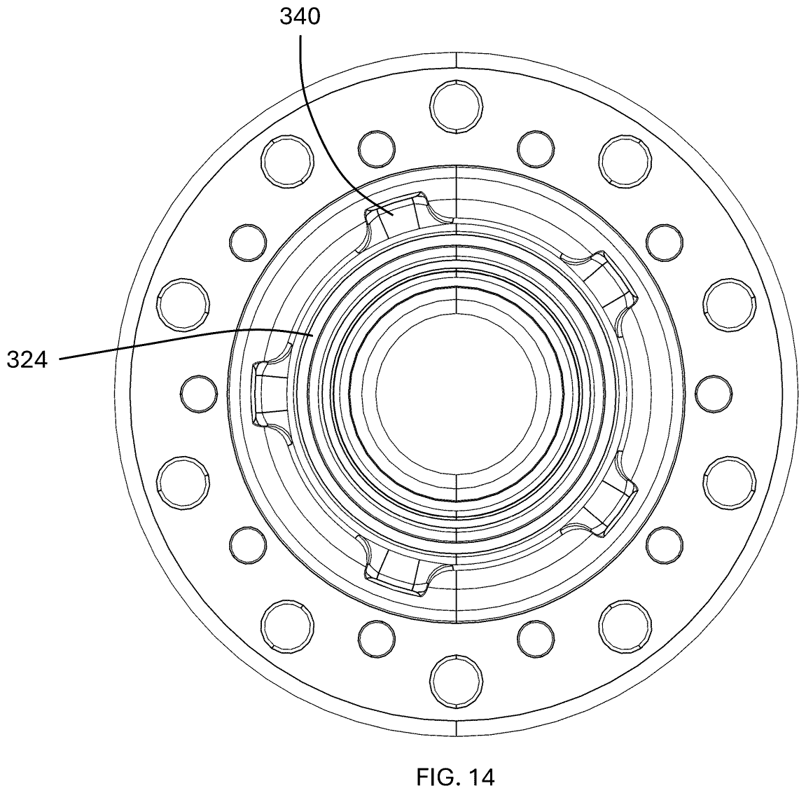

Regarding FIGS. 13 and 14, the wheel hub body 320 includes pilots 340 extending radially outward from an intermediate portion 343 of the side wall 324. The pilots 340 have circumferential spacings 344 therebetween. The pilots 340 each include an arcuate, axially extending pilot surface 342 to engage an annular, axially extending surface 350 (see FIG. 11) of the inboard pilot 308 of the rotor 304.

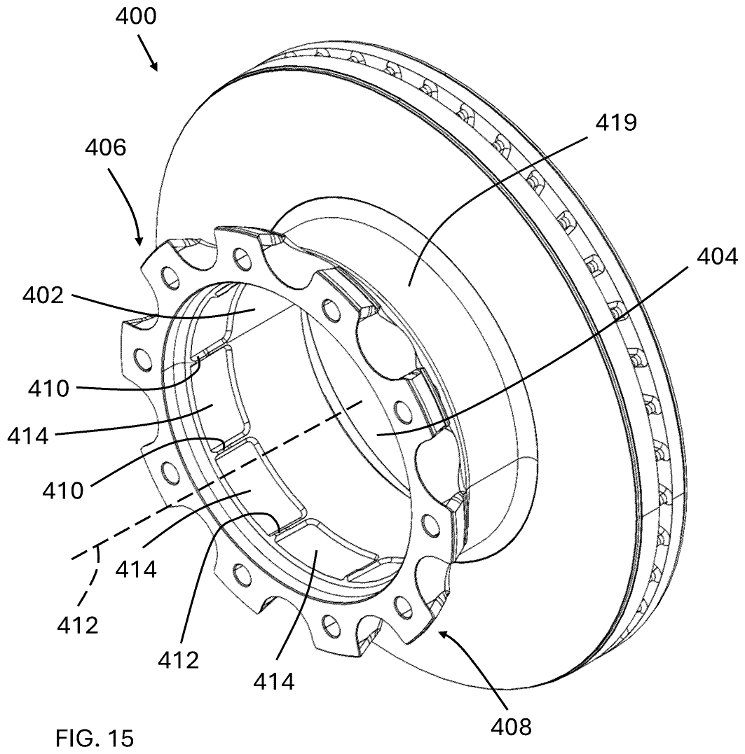

Regarding FIG. 15, a rotor 400 is provided that is similar in many respects to the rotor 14 discussed above. The rotor 400 includes an interior surface 402 extending around a central bore or interior 404 of the rotor 400. The rotor 400 has an outboard end portion 406 with a flange portion 408 and sacrificial pilots 410 extending along a central axis 412 of the rotor 400.

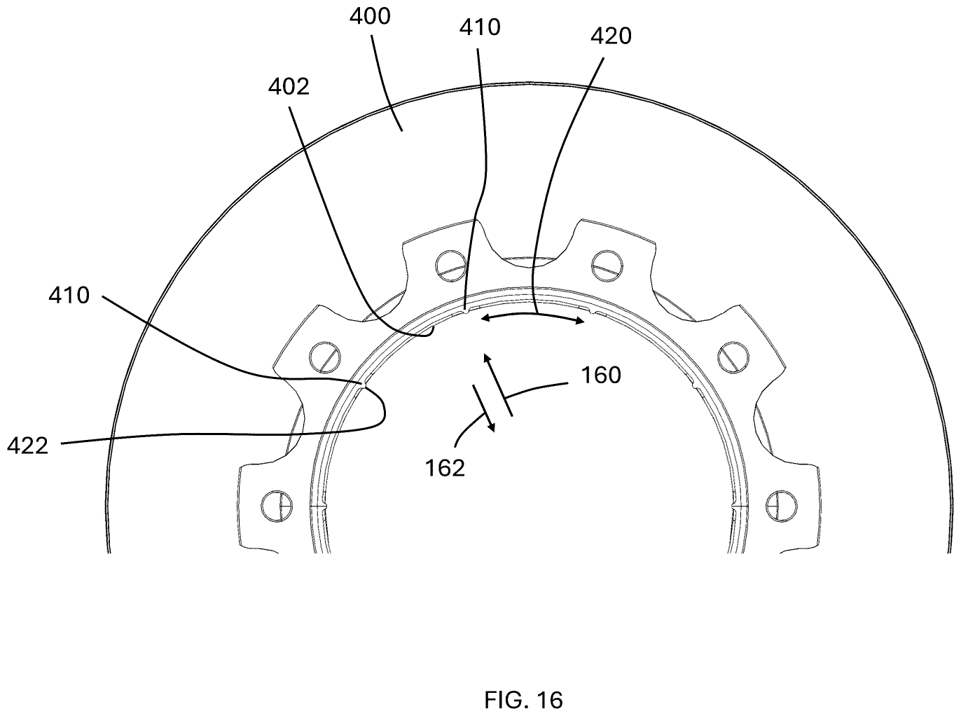

The sacrificial pilots 410 are circumferentially spaced apart by recesses 414 formed in the interior surface 402. Regarding FIG. 16, the pilots 410 are separated by circumferential spacings 420 around the interior surface 402. The pilots 410 have axially extending surfaces 422 for engaging one or more pilots of the associated wheel hub. The pilots 410 are narrow and make limited, nearly line contacts with the one or more pilots of the associated wheel hub. The relatively small amount of material of the pilots 410 may wear down quickly during operation of the vehicle.

Once the rotor 400 is installed as part of a vehicle wheel hub assembly, one or more of the pilots 410 initially contact one or more of the pilots, such as pilots 174 (see FIG. 5), of the wheel hub. The pilots 410 are made of a material that is weaker in wear than the material of the pilots of the wheel hub. Material resistance to wear can be compared using standard hardness tests, such as Rockwell and Brinell tests. In this manner, the one or more pilots of the wheel hub contacting the one or more of the pilots 410 wear down the pilots 410 until there is a radial spacing between the rotor pilots 410 and the wheel hub pilots. The wheel hub pilots may wear down the rotor pilots 410 as the wheel hub and rotor pilots move relative to one another such as in directions 160, 162 (see FIG. 16) during bending of the wheel hub, such as when the vehicle is traveling around a corner. The wheel hub pilots may also wear down the rotor pilots 410 due to thermal expansion and/or contraction of the wheel hub body (e.g., wheel hub body 13) and/or rotor 400. For example, the wheel hub body may undergo thermal expansion due to the ambient temperature and/or heat produced by friction within the bearing assemblies of the wheel hub. The thermal expansion of the wheel hub body may include a radial expansion of a wheel hub side wall (e.g., side wall portion 84) and radially outward movement of the wheel hub pilots into wearing engagement with the rotor pilots 410.

Once the pilots 410 have worn down and are out of contact with the wheel hub pilots, the rotor pilots 410 are unable to impart stress to the wheel hub 12. In this manner, the sacrificial pilot 410 operates to coaxially align the rotor 400 on a wheel hub during assembly and subsequently wears away to avoid the sacrificial pilot 400 imparting additional stress on the wheel hub during vehicle operation.

In one embodiment, the rotor 400 has a unitary, one-piece construction such that the pilot 400 is the same material as a barrel portion 419 of the rotor 400. In another embodiment, the pilot 400 includes a sacrificial member, such as a coating, that is made of a material different than the barrel portion 400. The sacrificial member may be a material, such as plastic, that wears away fastener than the material (e.g., a metallic material) of the barrel portion 419. The sacrificial member may wear off due to friction, or may burn off at elevated temperatures such as during braking of the vehicle.

In another embodiment, a pilot may be an insert, e.g., a distinct component that is assembled with the wheel hub and rotor 400 to facilitate concentric alignment of the rotor 400 on the wheel hub. For example, the pilot may be a ring, metal spring or flexure, a pad, or a bead of material. Other examples of pilots include an injection molded or stamped additional part or insert that is used to pilot the rotor 400 onto the outer diameter of the wheel hub and remains in place during operation of the vehicle.

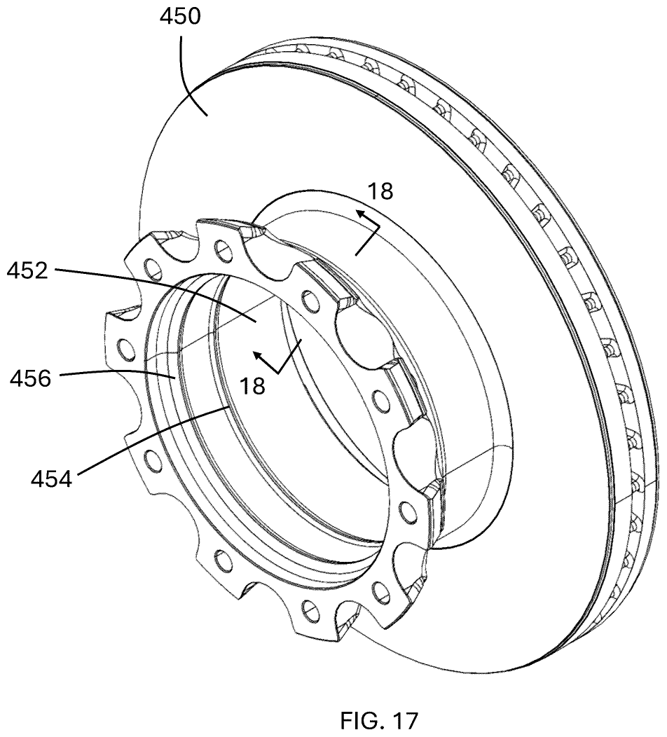

Regarding FIG. 17, a rotor 450 is provided that is similar in many respects to the rotor 14 discussed above. The rotor 450 has an interior surface 452 with an inboard sacrificial pilot 454 and an outboard sacrificial pilot 456. The inboard and outboard sacrificial pilots 454, 456 permit the rotor 450 to be used with wheel hubs having pilots at different axial locations, such as a drive hub or a steer hub. Like the sacrificial pilot 400, the inboard and outboard sacrificial pilots 454, 456 are configured to be worn down by a wheel hub pilot. Which sacrificial pilot 454, 456 contacts the wheel hub pilot, and is subsequently worn down, depends on the type of wheel hub.

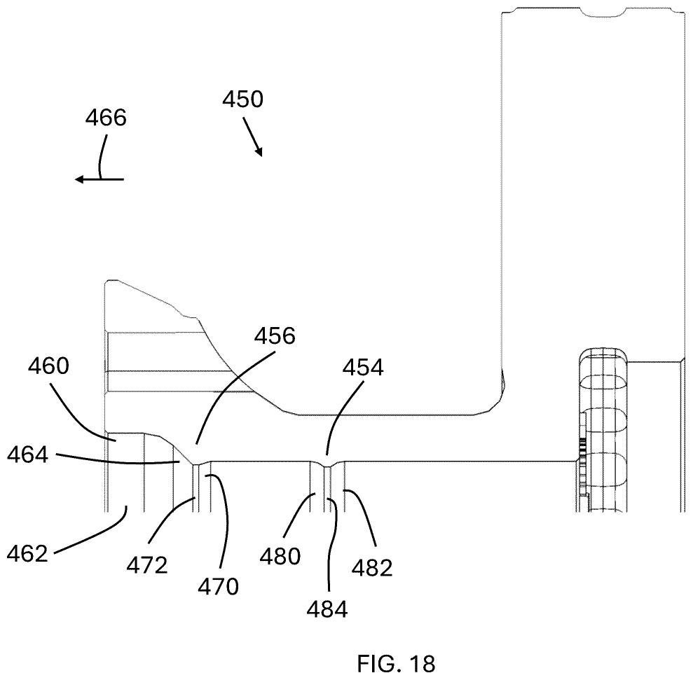

Regarding FIG. 18, the rotor 450 has an outboard opening 460 that opens to an interior 462 of the rotor 450. The outboard sacrificial pilot 456 has a tapered surface 464 to contact a pilot of the associated wheel hub as the rotor 450 is advanced in direction 466 onto the wheel hub and center the rotor 450 on the wheel hub. The tapered surface 464 provides a smooth transition surface to limit the outboard sacrificial pilot 456 catching on or damaging surfaces of the wheel hub as the rotor is positioned on the wheel hub.

The outboard sacrificial pilot 456 has a tapered surface 470 and an annular axially extending surface 472 connecting the surfaces 464, 470. Similarly, the inboard sacrificial pilot 454 has tapered surfaces 480, 482 and an annular axially extending surface 484. The surfaces 472, 484 provide a predetermined amount of axial engagement between the sacrificial pilot 454 or 456 and the associated pilot(s) of the wheel hub to ensure concentric alignment of the rotor 450 on the wheel hub.

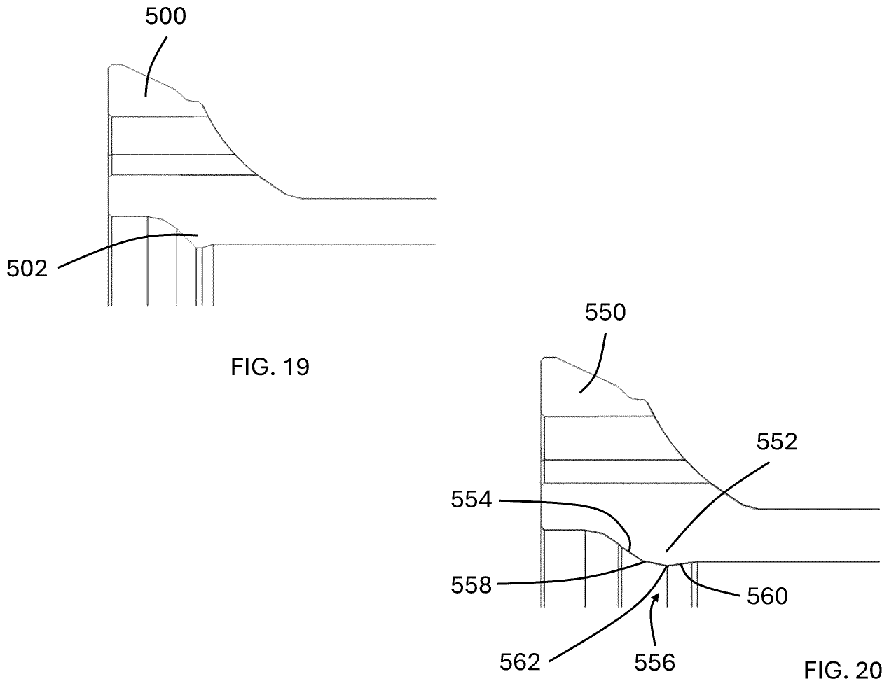

Regarding FIG. 19, a portion of a rotor 500 is shown, the rotor 500 being similar to the rotor 450 discussed above. One difference between the rotors 500, 450 is that the rotor 500 includes a single sacrificial pilot 502 whereas the rotor 450 has inboard and outboard sacrificial pilots 454, 456.

Regarding FIG. 20, a rotor 550 is provided having a sacrificial pilot 552 that provides a line contact on a corresponding pilot of the wheel hub. More specifically, the sacrificial pilot 552 has a tapered surface 554 to center the rotor 550 on the wheel hub and a crest or peak 556 that includes transversely extending tapered surfaces 558, 560 and a juncture 562 therebetween. The juncture 562 provides an annular edge for forming one or more arcuate line contacts with pilot(s) of the wheel hub and centering the rotor 550 on the wheel hub.

Various configurations of sacrificial pilots may be utilized. For example, the pilot of the rotor may be a circumferential pilot having one or more interruptions or a plurality of axial pilots each having one or more interruptions. As another example, the rotor may utilize points or circular bump outs as pilots.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims. For example, a wheel hub disclosed herein may be configured as a trailer wheel hub.

What is claimed is:

1. A U-shaped brake rotor for a wheel hub assembly, the U-shaped brake rotor comprising:
a body having a unitary, one-piece construction, the body rotatable around a central axis and having an interior to receive a wheel hub;
an inboard brake disc of the body;
an outboard mounting flange of the body;
an annular wall portion of the body connecting the inboard brake disc and the outboard mounting flange;
the outboard mounting flange extending radially outward of the annular wall relative to the central axis;
a lug of the outboard mounting flange having a through opening to receive a fastener to secure the lug to a wheel mounting flange of the wheel hub;
an inboard inclined surface of the lug extending radially outward as the inboard inclined surface extends away from the annular wall portion of the body; and
the inboard inclined surface of the lug extending around the through opening and including a radially outer portion radially outward of the through opening, a radially inner portion radially inward of the through opening, and an intermediate portion on either side of the through opening and connecting the radially outer and inner portions of the inboard inclined surface.

2. The U-shaped brake rotor of claim 1 wherein the radially outer portion of the inboard inclined surface of the lug is concave and inclined relative to the central axis.

3. The U-shaped brake rotor of claim 1 wherein the inboard inclined surface is concave and the radially outer portion, radially inner portion, and intermediate portions of the inboard inclined surface have a common radius of curvature.

4. The U-shaped brake rotor of claim 3 wherein the radius of curvature is in the range of 1.7 inches to approximately 2.2 inches.

5. The U-shaped brake rotor of claim 1 wherein the radially outer portion, radially inner portion, and intermediate portions extend continuously and without interruption around the through opening of the lug.

6. The U-shaped brake rotor of claim 1 wherein the lug includes a groove radially outward of the radially outer portion of the inboard inclined surface.

7. The U-shaped brake rotor of claim 6 wherein the lug comprises:
a juncture between the groove and the radially outer portion of the inboard inclined surface; and
a protruding portion extending inboard of the groove and including the radially outer portion of the inboard inclined surface thereon, the protruding portion defining a radially outermost portion of the through opening.

8. The U-shaped brake rotor of claim 1 wherein the lug includes a flared portion radially outward of the through opening, the flared portion extending radially outward as the flared portion extends outboard away from the inboard inclined surface; and
a groove connecting the flared portion and the inboard tapered surface.

9. The U-shaped brake rotor of claim 1 wherein the lug includes a flared portion outboard of the inboard inclined surface, the flared portion having an inclined surface that extends radially outward at an angle in the range of approximately 15 degrees to approximately 35 degrees relative to an axial direction as the inclined surface extends away from the inboard inclined surface.

10. The U-shaped brake rotor of claim 1 wherein the body includes a radially inner pilot to center the body on the wheel hub, the radially inner pilot of the body axially offset inboard of the outboard mounting flange.

11. The U-shaped brake rotor of claim 10 wherein the pilot is a sacrificial pilot.

12. The U-shaped brake rotor of claim 1 wherein the lug includes a plurality of lugs having circumferential spacings therebetween.

13. The U-shaped brake rotor of claim 1 wherein the inboard inclined surface of the lug is flat.

14. A U-shaped brake rotor for a wheel hub assembly, the U-shaped brake rotor comprising:
a body having a unitary, one-piece construction, the body rotatable around a central axis and having an interior to receive a wheel hub;
a brake disc of the body;
a mounting flange of the body to be secured to a wheel mounting flange of the wheel hub, the mounting flange spaced axially from the brake disc along the body;
a sacrificial pilot in the interior of the body to contact the wheel hub and center the body on the wheel hub; and
the sacrificial pilot configured to wear out of contact with the wheel hub during operation of the wheel hub assembly.

15. The U-shaped brake rotor of claim 14 wherein the body includes the sacrificial pilot.

16. The U-shaped brake rotor of claim 14 wherein the sacrificial pilot comprises an annular sacrificial pilot extending about the interior of the body.

17. The U-shaped brake rotor of claim 14 wherein the sacrificial pilot comprises a plurality of annular sacrificial pilots extending about the interior of the body and spaced axially apart along the body.

18. The U-shaped brake rotor of claim 14 wherein the sacrificial pilot comprises a radially inner contact surface to engage the wheel hub and tapered surfaces on either side of the radially inner contact surface.

19. The U-shaped brake rotor of claim 14 wherein the sacrificial pilot comprises a plurality of sacrificial pilots spaced apart about the interior of the body.

20. The U-shaped brake rotor of claim 14 wherein the sacrificial pilot comprises a plurality of elongate, axially extending sacrificial pilots spaced apart about the interior of the body.

21. The U-shaped brake rotor of claim 14 wherein the sacrificial pilot comprises an inboard tapered surface, an outboard tapered surface, and a juncture connecting the inboard and outboard tapered surfaces; and
wherein the juncture is configured to contact the wheel hub to center the body on the wheel hub.

22. The U-shaped brake rotor of claim 14 in combination with the wheel hub, the wheel hub including a wheel hub body made of a first material and having a unitary, one-piece construction;
wherein the wheel hub body includes the wheel mounting flange; and
wherein the body of brake rotor is made of a second material that is weaker in wear than the first material.

23. The U-shaped brake rotor of claim 22 wherein the first material of the wheel hub body is a non-ferrous material and the second material of the brake rotor is a ferrous material.

24. The U-shaped brake rotor of claim 14 wherein the sacrificial pilot includes an insert in the interior of the body.

25. The U-shaped brake rotor of claim 14 wherein the body includes an annular wall portion connecting the brake rotor and the mounting flange; and
wherein the mounting flange extends radially outward of the annular wall portion.
